(19) United States
(12) Patent Application Publication
(10) Pub. No.: US 2012/0248361 A1
(43) Pub. Date: Oct. 4, 2012

(54) CONNECTING STRUCTURE FOR VALVE ELEMENT AND VALVE STEM

(75) Inventors: DAISHI FUJIYAMA, OSAKA (JP); HAJIME YAMAGUCHI, OSAKA (JP)

(73) Assignee: KUBOTA CORPORATION

(21) Appl. No.: 13/079,216

(22) Filed: Apr. 4, 2011

(51) Int. Cl. F16K 1/22

(52) U.S. Cl. 251/308

(57) ABSTRACT

Valve stem holes (17) and pin holes (18) are formed on a valve element (3). A groove (23) is formed on the outer periphery of an insertion part (22) of a valve stem (4). In a state in which the insertion part (22) is inserted into the valve stem hole (17), the groove (23) and the pin hole (18) form an engaged part (27), and a connecting pin (16) is inserted into the pin hole (18) and is engaged with the engaged part (27) while being fit into the groove (23). In the engaged part (27), a pin contact face (30) of the connecting pin (16) is in surface contact with a groove contact face (26) in the bottom of the groove (23) and the groove contact face (26) is inclined with respect to a rotation axis (6) of the valve stem (4).

### FIELD OF THE INVENTION

The present invention relates to a connecting structure for the valve element and the valve stem of a butterfly valve.

### BACKGROUND OF THE INVENTION

In a connecting structure for the valve element and the valve stem of a butterfly valve according to the related art, as shown in FIGS. 17 and 18, a valve element 72 and a valve stem 73 are connected by, e.g., multiple T bolts 71. In this configuration, a valve stem hole 74 and multiple bolt insertion holes 75 are formed on the valve element 72. The bolt insertion holes 75 penetrate front and back sides 72a and 72b of the valve element 72 and communicate with the valve stem hole 74. On the valve stem 73, bolt through holes 77 are formed that are orthogonal to a rotation axis 76 and penetrate the valve stem 73 in the radial direction of the valve stem 73. In a state in which the end of the valve stem 73 is inserted into the valve stem hole 74, the bolt insertion holes 75 communicate with the bolt through holes 77, the T bolts 71 are inserted into the bolt insertion holes 75 and the bolt through holes 77, and nuts 78 are screwed onto the ends of the T bolts 71.

For example, Japanese Patent Laid-Open No. 2002-181202 describes the connecting structure for connecting the valve element 72 and the valve stem 73 by using the T bolts 71.

In the configuration of the related art, however, the bolt insertion holes 75 penetrate the front and back sides 72a and 72b of the valve element 72 and thus in a state in which a butterfly valve 70 is closed, a fluid may leak from an upstream side 81 (primary side) of the valve element 72 to a downstream side 82 (secondary side) of the valve element 72 through the bolt insertion holes 75 and the bolt through holes 77.

A fluid pressure applied to the valve element 72 depends on the opening of the valve element 72. The fluid pressure is maximized when the valve element 72 is fully closed. The fluid pressure is minimized when the valve element 72 is fully opened. When the valve element 72 has an intermediate opening, the fluid pressure is smaller than that of the fully closed valve element 72 and is larger than that of the fully opened valve element 72. The valve stem 73 is pressed in a removal direction (removal direction 83) from the valve element 72 by a fluid pressure in a valve box. A force pressing the valve stem 73 in the removal direction 83 varies with the opening of the valve element 72. Thus the valve stem 73 may be rattled against the valve element 72 in the removal direction 83 by the opening and closing of the valve element 72. Rattling means a phenomenon in which the valve stem 73 vibrates in the removal direction 83.

In order to reduce the rattling of the valve stem against the valve element 72, an operator bores the bolt insertion holes 75 on the valve element 72 and the bolt through holes 77 on the valve stem 73 so as to simultaneously ream (bore) the holes 75 and 77 with the end of the valve stem 73 inserted in the valve stem hole 74 of the valve element 72. Thus a difference between a diameter D of the holes 75 and 77 and a diameter d of the T bolt 71 decreases, reducing the rattling of the valve stem 73 against the valve element 72.

However, it takes a long time for the operator to simultaneously bore the bolt insertion holes 75 and the bolt through holes 77 thus with the end of the valve stem inserted in the valve stem hole 74 of the valve element 72.

An object of the present invention is to provide a connecting structure for a valve element and a valve stem which can prevent a fluid from leaking from the upstream side to the downstream side of the valve element when a butterfly valve is closed, prevent the rattling of the valve stem against the valve element, and achieve high machinability.

### DISCLOSURE OF THE INVENTION

In order to attain the object, a first invention is a connecting structure for the valve element and the valve stem of a butterfly valve, the valve element being disposed rotatably via the valve stem in a flow passage formed in a valve body,
wherein the valve element includes valve stem holes and pin holes communicating with the respective valve stem holes,
the valve stem is connected to the valve element by connecting pins and includes insertion parts inserted into the respective valve stem holes,
the valve stem includes grooves formed on the outer periphery of the insertion part,
the groove and the pin hole form an engaged part with the insertion part inserted into the valve stem hole,
the connecting pin is engaged with the engaged part while being inserted into the pin hole and fit into the groove,
the connecting pin has a pin contact face,
the groove has a groove contact face in the bottom of the groove,
the pin contact face is in surface contact with the groove contact face in the engaged part, and
the groove contact face is inclined with respect to the rotation axis of the valve stem.

With this configuration, the insertion part of the valve stem is inserted into the valve stem hole of the valve element, so that the engaged part is formed by the groove of the valve stem and the pin hole of the valve element. Further, the connecting pin is inserted into the pin hole, so that the connecting pin is fit into the groove and is engaged with the engaged part. Thus the valve stem and the valve element are connected via the connecting pin.

At this point in time, in the engaged part, the pin contact face is in surface contact with the groove contact face and the connecting pin is guided by the pin contact face and the groove contact face.

Assuming that a direction in which the insertion part of the valve stem is inserted into the valve stem hole of the valve element is an insertion direction, the fluid pressure of a fluid passing through the flow passage in the valve body applies a force to the valve stem in a removal direction opposite from the insertion direction, so that the valve stem may move in the removal direction.

However, the groove contact face inclined with respect to the rotation axis of the valve stem prevents (inhibits) the valve stem from being moved in the removal direction by the fluid pressure in a state in which the pin contact face is in surface contact with the groove contact face. Therefore, it is possible to prevent the valve stem from rattling against the valve element in the removal direction. Since the valve element and the valve stem always receive a fluid pressure in the valve body, a force in the insertion direction is not applied to the valve stem. Thus the valve stem does not move in the insertion direction so as to rattle against the valve element. Consequently, it is possible to prevent the valve stem from rattling against the valve element along the rotation axis.

A connecting structure for a valve element and a valve stem according to a second invention, wherein the grooves and the connecting pins are respectively provided at multiple points along the rotation axis of the valve stem, and

the groove contact face of one of the grooves is inclined in a different direction from the groove contact faces of the other grooves.

With this configuration, the pin contact faces of the connecting pins are in surface contact with the respective groove contact faces, so that the groove contact faces prevent the valve stem from being moved in the removal direction by a fluid pressure. Thus it is possible to prevent the valve stem from rattling against the valve element along the rotation axis.

A connecting structure for a valve element and a valve stem according to a third invention, wherein assuming that a direction in which the insertion part of the valve stem is inserted into the valve stem hole of the valve element along the rotation axis is an insertion direction,

the groove contact face is inclined such that the radial distance of the groove contact face from the rotation axis of the valve stem increases in the insertion direction.

With this configuration, even when a fluid pressure in the valve body applies a force to the valve stem in the removal direction, the pin contact face of the connecting pin is in surface contact with the groove contact face and thus the groove contact face prevents the valve stem from being moved in the removal direction by the fluid pressure. Consequently, it is possible to prevent the valve stem from rattling against the valve element in the removal direction.

When the butterfly valve is fabricated, an operator removes the insertion parts of the valve stems from the valve stem holes of the valve element and the valve element is separated from the valve stems. In this state, the pin holes can be formed on the valve element separately from the formation of the grooves on the insertion parts of the valve stems. Thus it is possible to easily form the pin hole and the groove.

A connecting structure for a valve element and a valve stem according to a fourth invention, wherein the pin hole does not penetrate the front and back sides of the valve element.

With this configuration, when the butterfly valve is closed, a fluid does not leak from the upstream side (primary side) of the valve element to the downstream side (secondary side) of the valve element through the pin hole.

### BRIEF DESCRIPTION OF THE DRAWINGS

FIG. 1 shows a longitudinal section from the front of a butterfly valve according to a first embodiment of the present invention;

FIG. 2 is a sectional view taken along line X-X of FIG. 1;

FIG. 3 shows a longitudinal section from a side of the butterfly valve;

FIG. 4 shows an exploded view of a connected part of a valve element and a valve stem in the butterfly valve, and a sectional view in a direction orthogonal to a rotation axis;

FIG. 5 is a sectional view taken along line X-X of FIG. 4;

FIG. 6 shows a longitudinal section of connected parts of the valve element and the valve stems in the butterfly valve along the rotation axis in a state in which connecting pins are not inserted into pin holes;

FIG. 7 is a sectional view taken along ling X-X of FIG. 6;

FIG. 8A is a Y-Y sectional view of FIG. 4, showing the connecting pin at the connected part of the valve element and the valve stem in the butterfly valve;

FIG. 8B is a Z-Z sectional view of FIG. 4, showing the connecting pin at the connected part of the valve element and the valve stem in the butterfly valve;

FIG. 9 shows a longitudinal section of the connected parts of the valve element and the valve stems in the butterfly valve along the rotation axis in a state in which the connecting pins are inserted into the pin holes;

FIG. 10 is a sectional view taken along line X-X of FIG. 9;

FIG. 11 shows a longitudinal section from the front of a butterfly valve according to a second embodiment of the present invention;

FIG. 12 is a sectional view showing a connected part of a valve element and a valve stem in a butterfly valve according to a third embodiment of the present invention, in a direction orthogonal to a rotation axis;

FIG. 13 is a sectional view showing a connected part of a valve element and a valve stem in a butterfly valve according to a fourth embodiment of the present invention, in a direction orthogonal to a rotation axis;

FIG. 14 shows a butterfly valve according to a fifth embodiment of the present invention;

FIG. 15 is a sectional view showing a connected part of a valve element and a valve stem in the butterfly valve according to the fifth embodiment of the present invention, in a direction orthogonal to a rotation axis;

FIG. 16 is a sectional view showing a connected part of a valve element and a valve stem in a butterfly valve according to a sixth embodiment of the present invention, in a direction orthogonal to a rotation axis;

FIG. 17 shows a connected part of a valve element and a valve stem in a butterfly valve according to the related art; and

FIG. 18 is a sectional view taken along line X-X of FIG. 17.

### DESCRIPTION OF THE EMBODIMENTS

The following will describe embodiments of the present invention in accordance with the accompanying drawings.

### First Embodiment

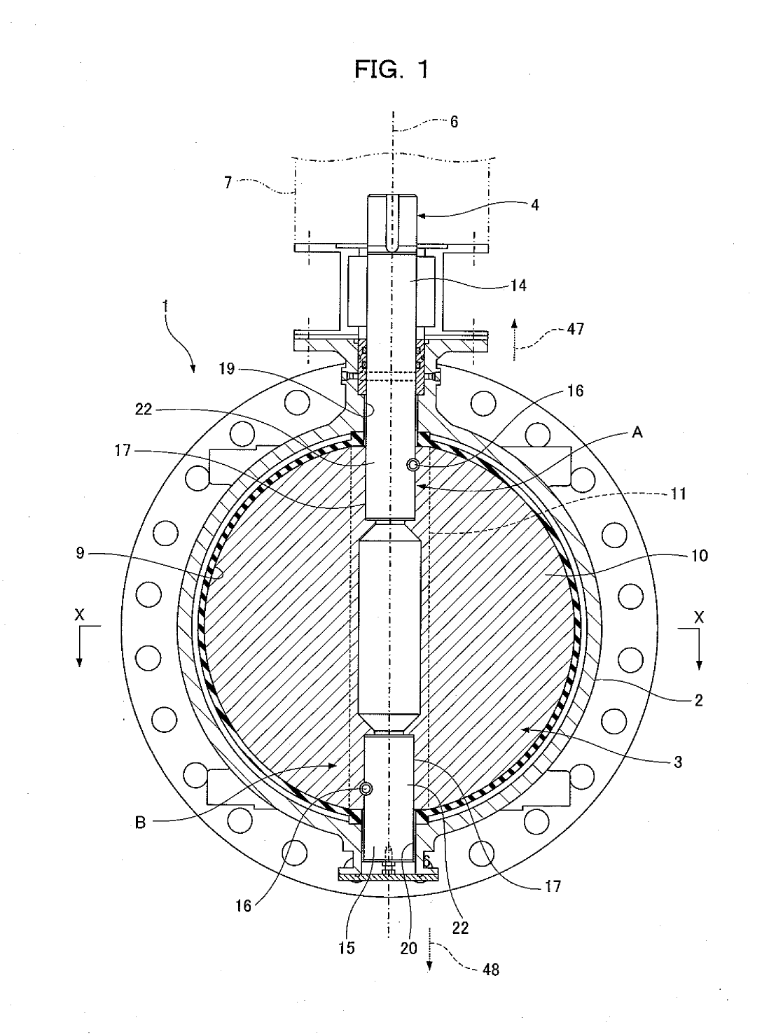

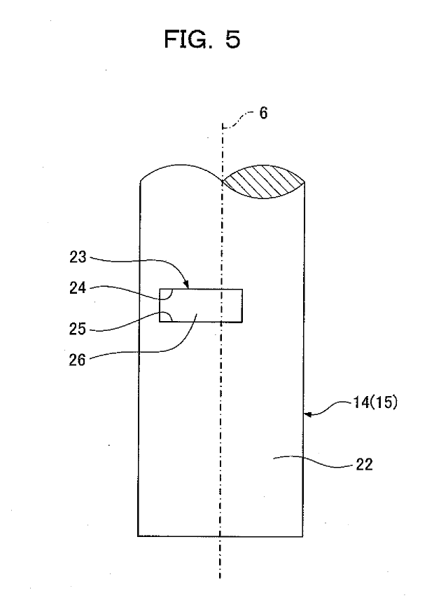

Referring to FIGS. 1 to 10, a first embodiment will be first described below.

As shown in FIGS. 1 to 3, reference numeral 1 denotes a concentric butterfly valve in which a valve element 3 is disposed in a valve body 2 so as to rotate via a valve stem 4. The concentric butterfly valve means that the valve can rotate about a rotation axis 6 on which the valve stem 4 and the valve element 3 are vertically formed.

The valve body 2 is a cylindrical member in which a flow passage 8 is formed. On the inner surface of the valve body 2, a sheet member 9 is provided that is made of an elastic material such as rubber. The valve element 3 has a disc-like body part 10 and a cylindrical boss 11 provided on the body part 10. The rotation axis 6 passes the center of the boss 11.

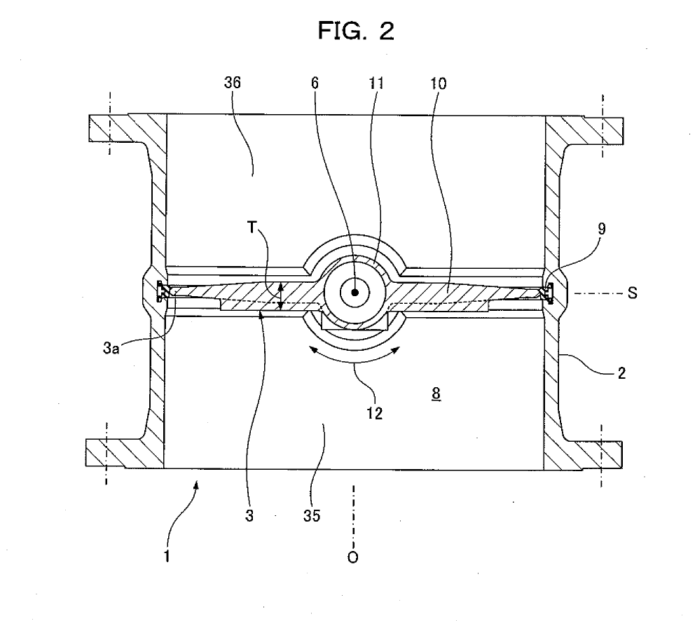

As shown in FIG. 2, the valve element 3 is rotated to a fully closed position S, so that an outer edge 3a of the valve element 3 is pressed to the sheet member 9 so as to close the flow passage 8 in the valve body 2. Further, the valve element 3 is rotated to a fully opened position O, so that the outer edge 3a of the valve element 3 is separated from the sheet member 9 so as to open the flow passage 8 in the valve body 2. In the concentric butterfly valve 1, the outer edge 3a of the valve element 3 and the rotation axis 6 are contained in the same plane.

The valve stem 4 is divided into an upper valve stem 14 and a lower valve stem 15. The upper valve stem 14 and the valve element 3 are connected to each other via a connecting pin 16, and the lower valve stem 15 and the valve element 3 are similarly connected to each other via another connecting pin 16. Further, the upper valve stem 14 is inserted into a hole 19 formed on the upper part of the valve body 2 and the lower valve stem 15 is inserted into a hole 20 formed on the lower part of the valve body 2. To the upper valve stem 14, a rotating unit 7 is connected by which rotary power is automatically or manually applied to the valve stem 4.

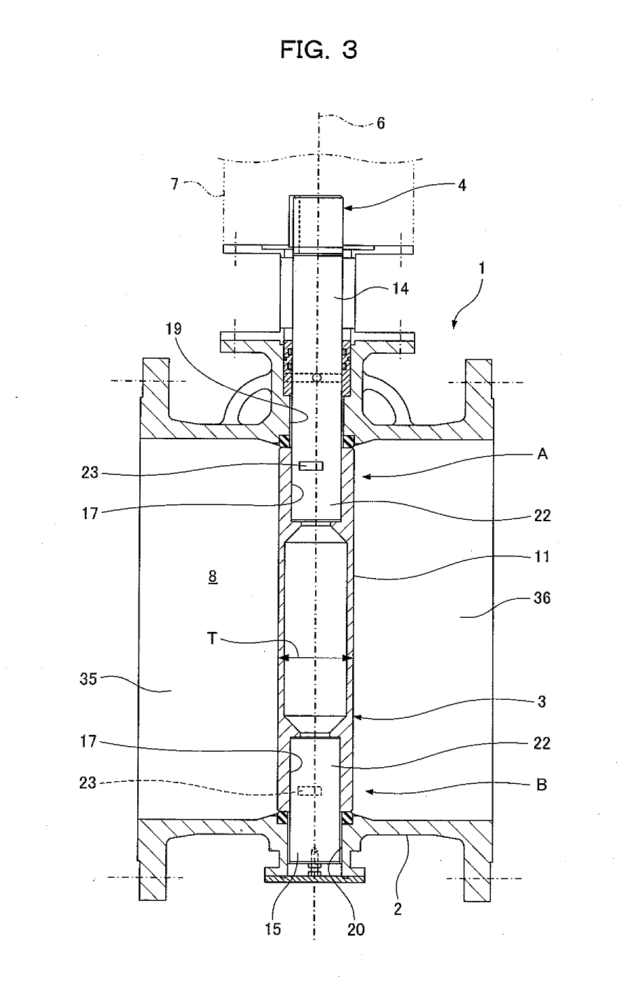

The following will describe a connecting structure A for the upper valve stem 14 and the valve element 3 in FIGS. 1 and 3.

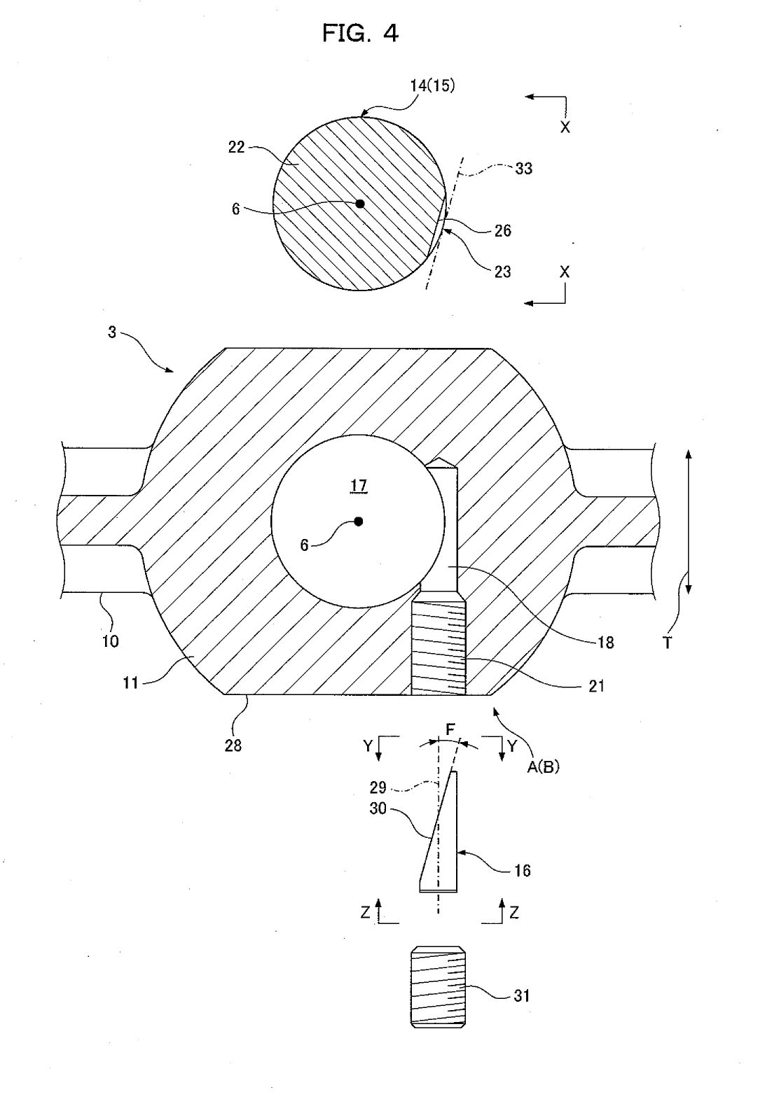

As shown in FIG. 4, a valve stem hole 17 and a pin hole 18 communicating with the valve stem hole 17 are formed on the upper part of the boss 11 of the valve element 3. The valve stem hole 17 is formed along the rotation axis 6 (that is, in the vertical direction). Further, the pin hole 18 is formed in parallel with a thickness direction T of the valve element 3. The rear side of the pin hole 18 communicates with the valve stem hole 17 in a tangential direction. Moreover, an internal thread 21 is formed at the front of the pin hole 18.

As shown in FIGS. 4 to 6, the upper valve stem 14 has an insertion part 22 to be inserted into the valve stem hole 17. On the outer periphery of the insertion part 22, a groove 23 is formed. The groove 23 is recessed when viewed in the direction of a tangent line 33 of the upper valve stem 14. The groove 23 includes a pair of sides 24 and 25 opposed to each other along the rotation axis 6 and a groove contact face 26 formed on a bottom part between the sides 24 and 25.

As shown in FIG. 4, the groove contact face 26 is a flat face that is parallel with the tangent line 33 of the valve stem 4. As shown in FIG. 6, assuming that a direction in which the insertion part 22 of the upper valve stem 14 is inserted into the valve stem hole 17 on the upper part of the valve element 3 along the rotation axis 6 is an insertion direction 37, the groove contact face 26 of the upper valve stem 14 is inclined diagonally upward at a proper angle E such that a radial distance C from the rotation axis 6 increases along the insertion direction 37.

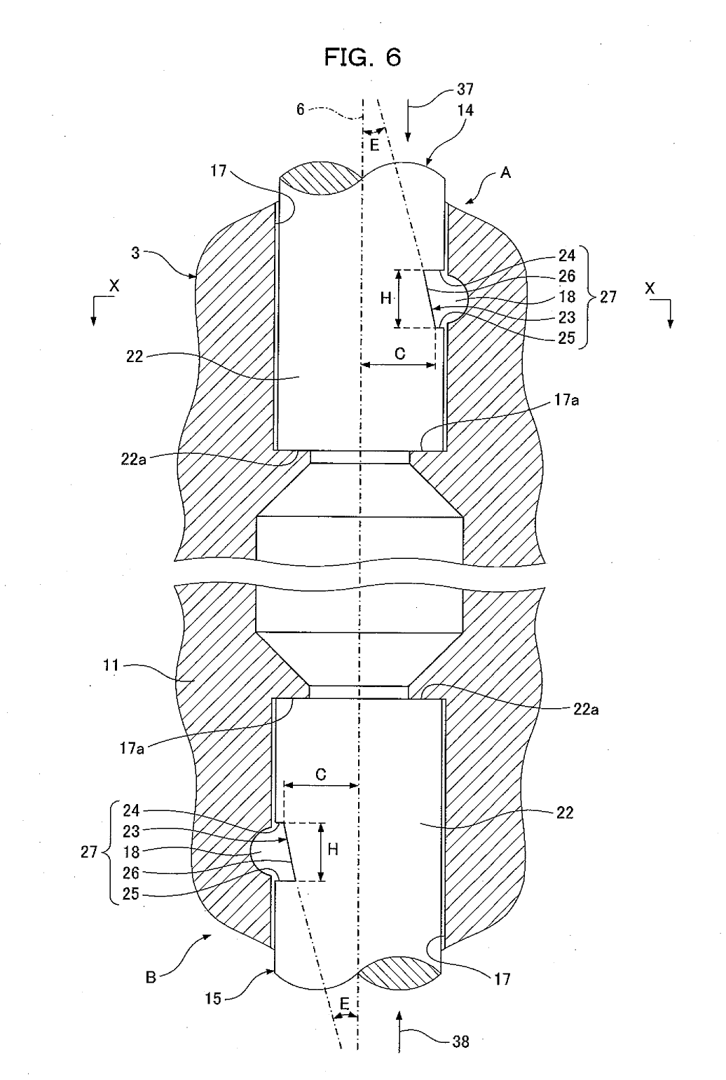

As shown in FIGS. 6 and 7, in a state in which the insertion part 22 of the upper valve stem 14 is inserted into the valve stem hole 17, an end face 22a of the insertion part 22 is in contact with a rear end face 17a of the valve stem hole 17, and an engaged part 27 is formed by the groove 23 and the pin hole 18. The engaged part 27 is a space surrounded by the groove 23 and the pin hole 18 and decreases in sectional area toward the rear. The pin hole 18 does not penetrate the front and back sides of the valve element 3 and is opened only on a surface 28 on one of the front and back sides of the valve element 3.

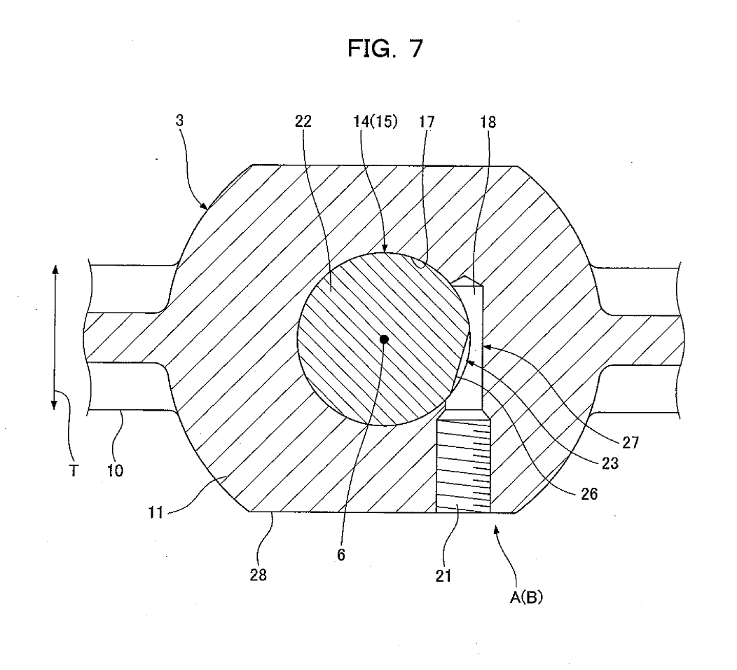

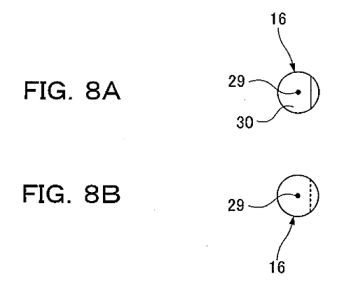

As shown in FIGS. 4, 8A, and 8B, the connecting pin 16 is fabricated by diagonally cutting a rod member that is circular in cross section. The connecting pin 16 has a pin contact face 30 inclined from an axis 29 and is wedge-shaped so as to decrease in thickness toward the tip. Further, the pin contact face 30 crosses the axis 29 at a proper angle F. As shown in FIG. 6, the groove 23 has a size H along the rotation axis 6, the size H being slightly larger than the diameter of the connecting pin 16

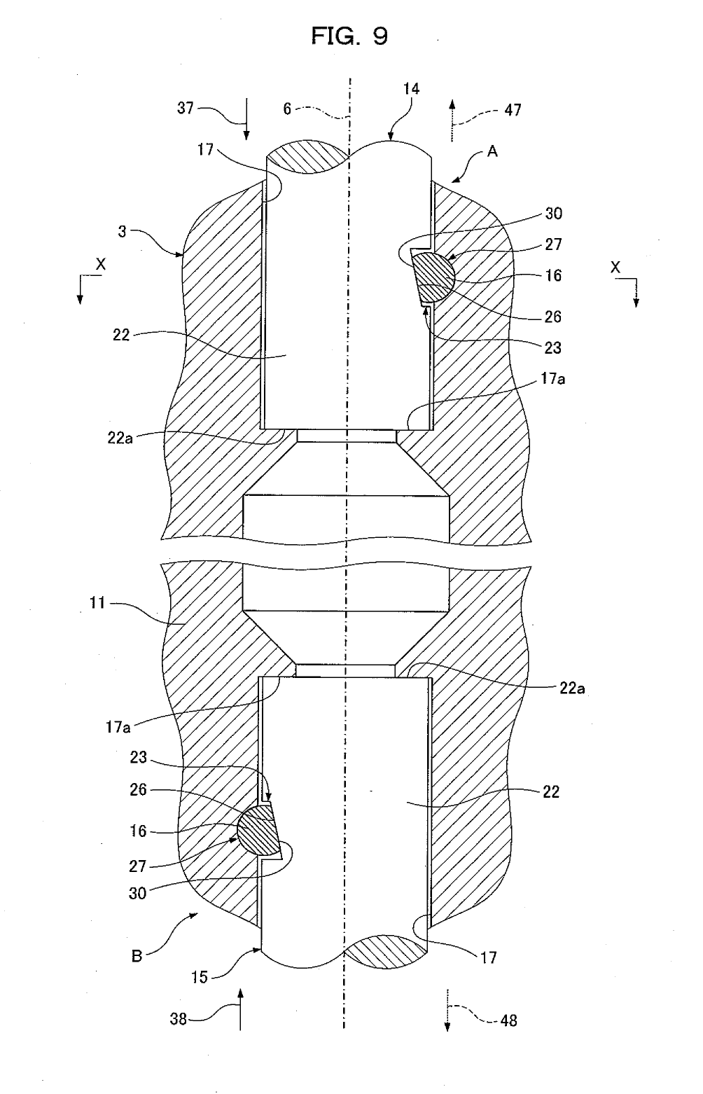

As shown in FIGS. 9 and 10, the connecting pin 16 is inserted into the pin hole 18 from the end and is engaged with the engaged part 27 while being fit into the groove 23. In this case, the pin contact face 30 is in surface contact with the groove contact face 26 in the engaged part 27. The pin contact face 30 and the groove contact face 26 indicate surfaces in surface contact.

In the pin hole 18, a stopper screw 31 (an example of a stopper) is provided that prevents the connecting pin 16 from being detached from the pin hole 18. The stopper screw 31 is screwed on the internal thread 21. The internal thread 21 presses the connecting pin 16 in an insertion direction 34.

Referring to FIGS. 1 and 3, the following will describe a connecting structure B for the lower valve stem 15 and the valve element 3.

The connecting structure B is configured like the connecting structure A. Specifically, as shown in FIG. 6, a valve stem hole 17 and a pin hole 18 are formed in the lower part of the boss 11 of the valve element 3, and an insertion part 22 of the lower valve stem 15 is inserted into the lower valve stem hole 17. Further, a groove 23 is formed on the outer periphery of the insertion part 22.

The groove 23 of the lower valve stem 15 has a groove contact face 26 inclined oppositely from the inclination direction of the groove contact face 26 provided in the groove 23 of the upper valve stem 14 in the connecting structure A. Specifically, assuming that a direction in which the insertion part 22 of the lower valve stem 15 is inserted into the valve stem hole 17 on the lower part of the valve element 3 along the rotation axis 6 is an insertion direction 38, the lower groove contact face 26 is inclined diagonally downward at a proper angle E such that a radial distance C from the rotation axis 6 increases along the insertion direction 38.

In a state in which the insertion part 22 of the lower valve stem 15 is inserted into the lower valve stem hole 17, an end face 22a of the insertion part 22 is in contact with a rear end face 17a of the valve stem hole 17. Further, an engaged part 27 is formed by the groove 23 and the pin hole 18. The lower pin hole 18 does not penetrate the front and back sides of the valve element 3 and is opened only on the surface 28 on one of the front and back sides of the valve element 3. In the pin hole 18, a stopper screw 31 (an example of a stopper) is provided.

The effect of the configuration will be described below.

In the assembly of the butterfly valve 1, the valve element 3 is inserted into the valve body 2 and then the upper valve stem 14 is inserted into the hole 19 of the valve body 2. As shown in FIGS. 6 and 7, the insertion part 22 of the upper valve stem 14 is inserted into the upper valve stem hole 17 of the boss 11. Thus the engaged part 27 is formed by the groove 23 of the upper valve stem 14 and the upper pin hole 18. As shown in FIGS. 9 and 10, an operator inserts and presses the connecting pin 16 into the pin hole 18 from the end, so that the connecting pin 16 is fit into the groove 23, is engaged with the engaged part 27, and rotates about the axis 29. Thus the pin contact face 30 comes into surface contact with the groove contact face 26, so that the upper valve stem 14 and the valve element 3 are connected to each other via the connecting pin 16.

In this case, the connecting pin 16 is guided to the pin contact face 30 and the groove contact face 26. Thus as the connecting pin 16 is inserted into the pin hole 18, a force G (see FIG. 10) is outwardly applied to the connecting pin 16 in the radial direction of the upper valve stem 14 and presses the connecting pin 16 to the inner surface of the pin hole 18. Thus it is possible to prevent the upper valve stem 14 from rattling against the valve element 3 in a circumferential direction 12 (rotation direction) of the valve stem 14.

Similarly, the lower valve stem 15 is inserted into the hole 20 of the valve body 2 and the insertion part 22 of the lower valve stem 15 is inserted into the lower valve stem hole 17 of the boss 11. As shown in FIGS. 9 and 10, the operator inserts and presses the connecting pin 16 into the lower pin hole 18, so that the connecting pin 16 is fit into the groove 23, is engaged with the engaged part 27, and rotates about the axis 29. Thus the pin contact face 30 comes into surface contact with the groove contact face 26, so that the lower valve stem 15 and the valve element 3 are connected to each other via the connecting pin 16. Hence, it is possible to similarly prevent the lower valve stem 15 from rattling against the valve element 3 in the circumferential direction 12 (rotation direction) of the valve stem 15.

The upper and lower pin holes 18 do not penetrate the front and back sides of the valve element 3 and are opened only on the surface 28 on one of the front and back sides of the valve element 3. Hence, in a state in which the valve element 3 is set at the fully closed position S as shown in FIG. 2, there is no possibility that a fluid in the valve body 2 may leak from an upstream side 35 (primary side) to a downstream side 36 (secondary side) of the valve element 3 through the pin hole 18.

As shown in FIG. 9, the fluid pressure of a fluid passing through the flow passage 8 in the valve body 2 applies a force that may move the upper valve stem 14 in a removal direction 47 opposite from the insertion direction 37 (that is, outwardly in the radial direction of the axis of the flow passage 8).

Thus as shown in FIG. 6, in the upper connecting structure A, the groove contact face 26 of the groove 23 is inclined such that the radial distance C from the rotation axis 6 increases in the insertion direction 37 (downward). As shown in FIG. 9, since the pin contact face 30 of the connecting pin 16 is in surface contact with the groove contact face 26, the groove contact face 26 prevents (inhibits) the upper valve stem 14 from being moved in the removal direction 47 (upward) by the fluid pressure of the flow passage 8. Thus it is possible to prevent the upper valve stem 14 from rattling against the valve element 3 in the removal direction 47.

Further, the valve element 3 and the upper valve stem 14 always receive a fluid pressure in the valve body 2 and thus a force in the insertion direction 37 is not applied to the upper valve stem 14. Therefore, it is possible to prevent the upper valve stem 14 from moving and rattling against the valve element 3 in the insertion direction 37, thereby preventing the upper valve stem 14 from rattling against the valve element 3 along the rotation axis 6 (in the vertical direction).

Similarly, in the lower connecting structure B, the groove contact face 26 of the groove 23 is inclined as shown in FIG. 6 such that the radial distance C from the rotation axis 6 increases in the insertion direction 38 (upward). As shown in FIG. 9, since the pin contact face 30 of the connecting pin 16 is in surface contact with the groove contact face 26, the groove contact face 26 prevents (inhibits) the lower valve stem 15 from being moved in a removal direction 48 (downward) by the fluid pressure of the flow passage 8. Hence, it is possible to prevent the lower valve stem 15 from rattling against the valve element 3 in the removal direction 48 (that is, outwardly in the radial direction of the axis of the flow passage 8).

Further, the valve element 3 and the lower valve stem 15 always receive a fluid pressure in the valve body 2 and thus a force in the insertion direction 38 is not applied to the lower valve stem 15. Therefore, it is possible to prevent the lower valve stem 15 from moving and rattling against the valve element 3 in the insertion direction 38, thereby preventing the lower valve stem 15 from rattling against the valve element 3 along the rotation axis 6 (in the vertical direction).

Consequently, it is possible to prevent the valve stems 14 and 15 from rattling against the valve element 3 in the circumferential direction 12 of the valve stems 14 and 15 and along the rotation axis 6.

As shown in FIG. 10, in each of the connecting structures A and B, the connecting pin 16 is wedge-shaped and is fit into the engaged part 27, so that the valve element 3 and the valve stems 14 and 15 are connected to each other. Thus when the butterfly valve 1 is fabricated, the operator removes the insertion parts 22 of the valve stems 14 and 15 from the valve stem holes 17 of the valve element 3 and the valve element 3 is separated from the valve stems 14 and 15. In this state, the pin hole 18 can be formed on the valve element 3 separately from the formation of the groove 23 on the insertion part 22. Thus it is possible to easily form the pin hole 18 and the groove 23.

As has been discussed, it is not necessary to form the pin hole 18 with the valve element 3 and the valve stem 4 assembled and the pin hole 18 can be formed separately from the formation of the valve stems 14 and 15, so that the productivity is improved.

Further, the pin hole 18 is formed separately from the formation of the groove 23, the insertion part 22 is inserted into the valve stem hole 17, and the connecting pin 16 is fit into the engaged part 27, so that the valve element 3 and the valve stem 4 are assembled.

As shown in FIG. 4, the pin hole 18 is formed in parallel with the thickness direction T of the valve element 3. Thus the operator can easily insert the connecting pin 16 into the pin hole 18 without being interfered by the valve element 3, unlike in the case where the pin hole 18 is formed perpendicularly to the thickness direction T of the valve element 3 or formed in a tilted manner.

### Second Embodiment

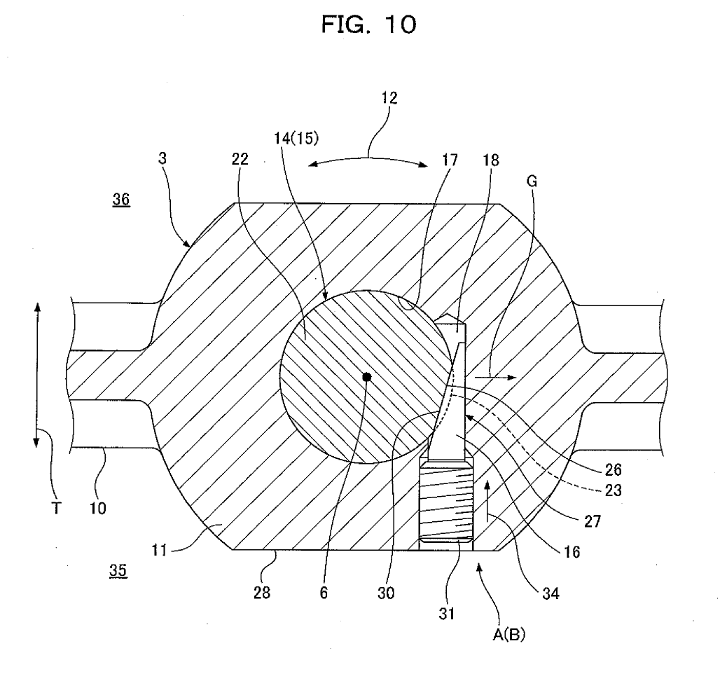

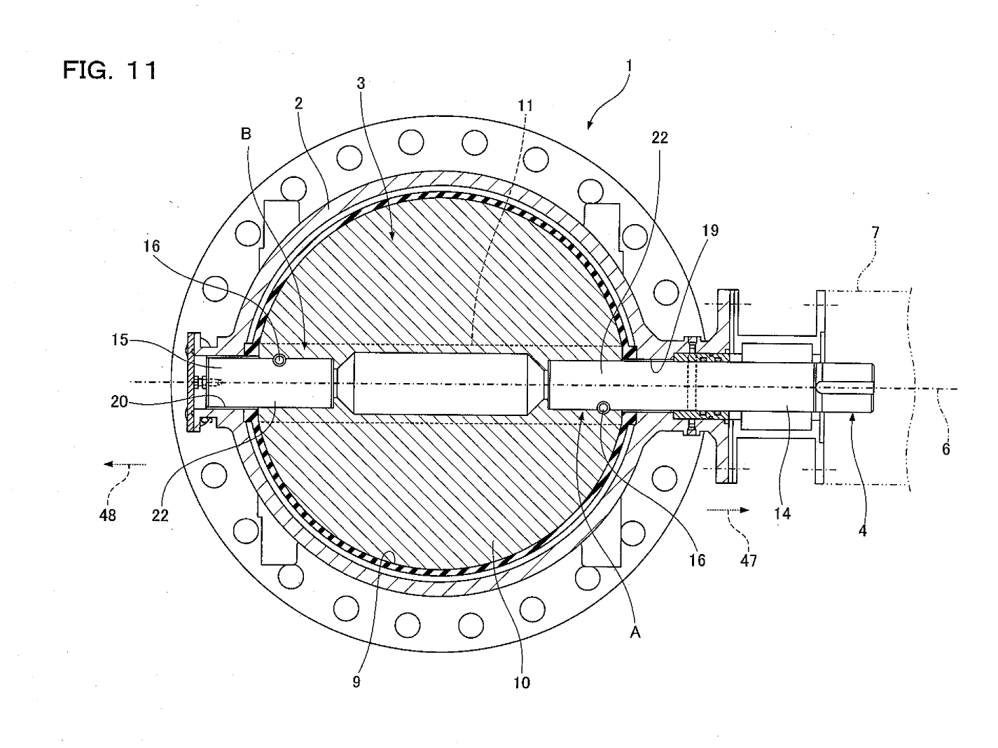

In the first embodiment, as shown in FIG. 1, the butterfly valve 1 is installed with the rotation axis 6 extended in the vertical direction. In a second embodiment, as shown in FIG. 11, a butterfly valve 1 is installed with a rotation axis 6 extended in a horizontal direction. A connecting structure A for a valve stem 14 and a valve element 3 and a connecting structure B for a valve stem 15 and the valve element 3 are identical to the upper connecting structure A and the lower connecting structure B of the first embodiment.

With this configuration, as in the first embodiment, there is no possibility that a fluid in a valve body 2 may leak from an upstream side 35 (primary side) to a downstream side 36 (secondary side) of the valve element 3 through a pin hole 18 when the valve element 3 is set at a fully closed position S. Further, it is possible to prevent the valve stems 14 and 15 from rattling against the valve element 3 in a circumferential direction 12 of the valve stems 14 and 15 and along the rotation axis 6 (in the horizontal direction) and easily form the pin hole 18 and a groove 23.

### Third Embodiment

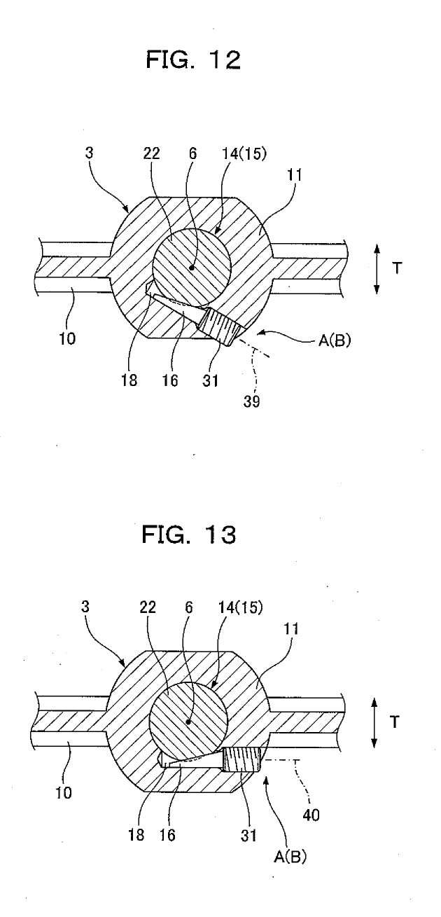

In the first embodiment, as shown in FIG. 10, the pin hole 18 is formed in parallel with the thickness direction T of the valve element 3, whereas in a third embodiment, as shown in FIG. 12, a pin hole 18 is formed in a diagonal direction 39 with respect to a thickness direction T of a valve element 3.

### Fourth Embodiment

In a fourth embodiment, as shown in FIG. 13, a pin hole 18 formed in a direction 40 orthogonal to a thickness direction T of a valve element 3.

### Fifth Embodiment

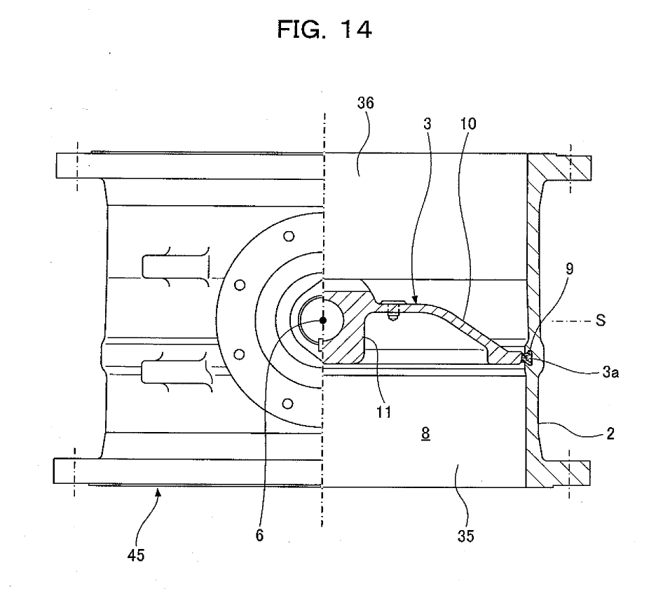

The first to fourth embodiments described the concentric butterfly valve 1 as shown in FIG. 2. In a fifth embodiment, an eccentric butterfly valve 45 may be used as shown in FIGS. 14 and 15. In the eccentric butterfly valve 45, an outer edge 3a of a valve element 3 and a rotation axis 6 are not contained in the same plane.

Connecting structures A and B for valve stems 14 and 15 and the valve element 3 in the eccentric butterfly valve 45 are identical to those of the first embodiment.

### Sixth Embodiment

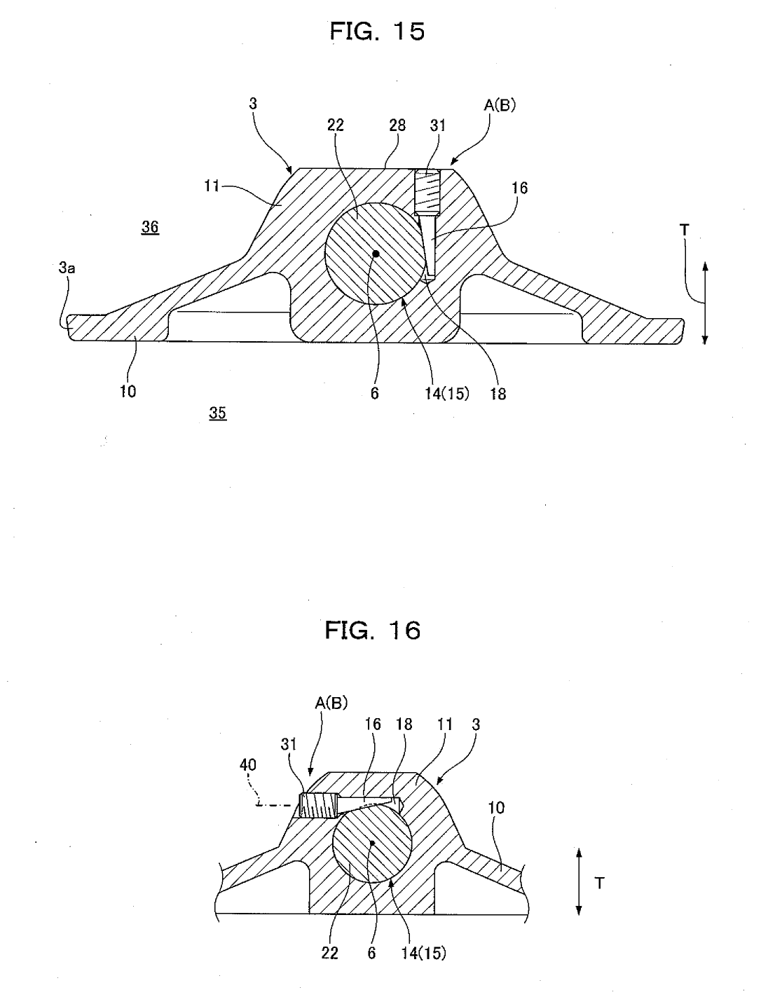

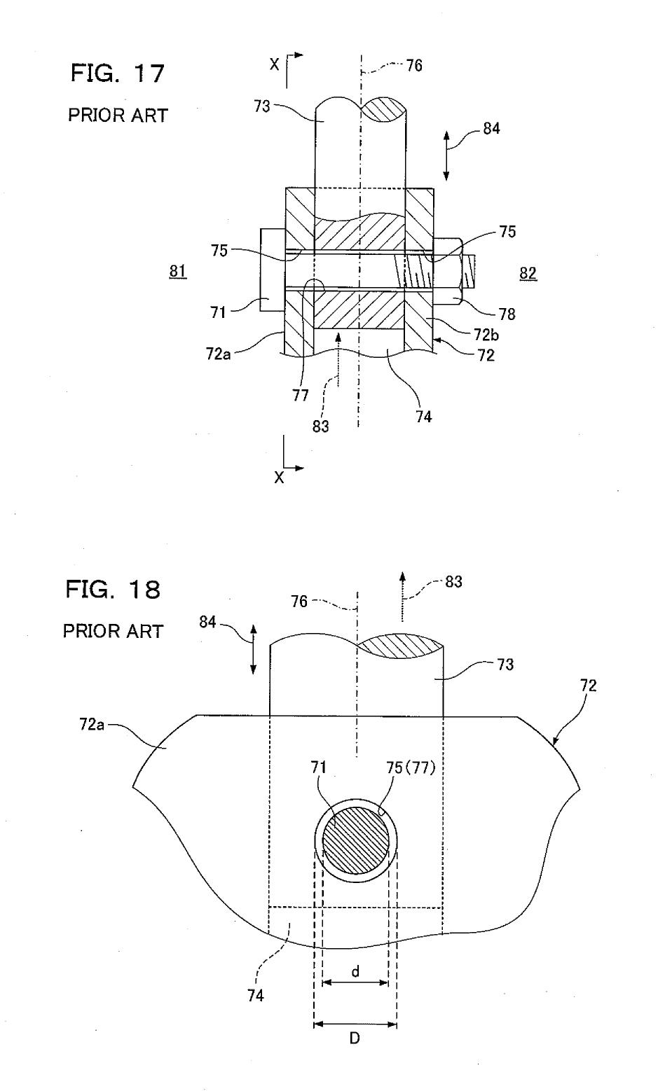

In the fifth embodiment, as shown in FIG. 15, a pin hole 18 is formed in parallel with a thickness direction T of the valve element 3, whereas in a sixth embodiment, as shown in FIG. 16, a pin hole 18 is formed in a direction 40 orthogonal to a thickness direction T of a valve element 3.

In the fifth embodiment, since the pin hole 18 is formed in parallel with the thickness direction T of the valve element 3 as shown in FIG. 15, a connecting pin 16 can be easily inserted into the pin hole 18 without causing the valve element 3 to interfere with an operator, unlike in the case where the pin hole 18 is formed perpendicularly (see FIG. 16) or diagonally to the thickness direction T of the valve element 3.

In the sixth embodiment, the pin hole 18 is formed in the direction 40 orthogonal to the thickness direction T of the valve element 3. The pin hole 18 may be formed in a direction 39 diagonal to the thickness direction T of the valve element 3 as in FIG. 12.

In the foregoing embodiments, the connecting pins 16, the pin holes 18, and the grooves 23 are provided at two points (multiple points) along the rotation axis 6 but may be provided at three or more points.

In the foregoing embodiments, as shown in FIG. 1, the valve stem 4 is divided into the upper valve stem 14 and the lower valve stem 15. A single valve stem may be used instead of the divided valve stems. In this case, the connecting pins 16, the pin holes 18, and the grooves are provided at multiple points along the rotation axis 6. At least one of the grooves 23 formed on the single valve stem has the groove contact face 26 inclined oppositely to the groove contact faces 26 of the other grooves 23 with respect to the rotation axis 6.

In the foregoing embodiments, the single connecting pin 16 is provided for the pair of the valve stem 14 and the valve stem hole 17 in the connecting structure A. The present invention is not limited to this configuration. The multiple connecting pins 16 may be provided for the pair of the valve stem 14 and the valve stem hole 17. In this case, at least one of the grooves 23 formed on the valve stem 14 has the groove contact face 26 inclined oppositely to the groove contact faces 26 of the other grooves 23 with respect to the rotation axis 6 of the valve stem 14. Thus it is possible to prevent (inhibit) the valve stem 14 from moving in any directions along the rotation axis 6 and prevent the valve stem 14 from rattling against the valve element 3. Similarly, in the connecting structure B, the multiple connecting pins 16 may be provided for the pair of the valve stem 15 and the valve stem hole 17. Also in this case, the same effect can be obtained.

What is claimed is:

1. A connecting structure for a valve element and a valve stem of a butterfly valve, the valve element being disposed rotatably via the valve stem in a flow passage formed in a valve body,
wherein the valve element comprises valve stem holes and pin holes communicating with the respective valve stem holes,
the valve stem is connected to the valve element by connecting pins and comprises insertion parts inserted into the respective valve stem holes,
the valve stem comprises grooves formed on an outer periphery of the insertion part,
the groove and the pin hole form an engaged part with the insertion part inserted into the valve stem hole,
the connecting pin is engaged with the engaged part while being inserted into the pin hole and fit into the groove,
the connecting pin has a pin contact face,
the groove has a groove contact face in a bottom of the groove,
the pin contact face is in surface contact with the groove contact face in the engaged part, and
the groove contact face is inclined with respect to a rotation axis of the valve stem.

2. The connecting structure for the valve element and the valve stem according to claim 1, wherein the grooves and the connecting pins are respectively provided at multiple points along the rotation axis of the valve stem, and
the groove contact face of one of the grooves is inclined in a different direction from the groove contact faces of the other grooves.

3. The connecting structure for the valve element and the valve stem according to claim 1, wherein assuming that a direction in which the insertion part of the valve stem is inserted into the valve stem hole of the valve element along the rotation axis is an insertion direction,
the groove contact face is inclined such that a radial distance of the groove contact face from the rotation axis of the valve stem increases in the insertion direction.

4. The connecting structure for the valve element and the valve stem according to claim 1, wherein the pin hole does not penetrate front and back sides of the valve element.
